(19) United States
(12) Patent Application Publication
(10) Pub. No.: US 2005/0232683 A1
(43) Pub. Date: Oct. 20, 2005

(54) Oral composition applicator devices including piercing section and related methods

(76) Inventors: Mark A. Zeh, Munchen (DE); Aaron Richard Sevier, San Francisco, CA (US); John Smith, San Francisco, CA (US); Nancy J. Serpiello, Menlo Park, CA (US); William Smith, Sunnyvale, CA (US)

Correspondence Address: PFIZER, INC., 201 TABOR ROAD, MORRIS PLAINS, NJ, 07950, US

(21) Appl. No.: 10/825,812

(22) Filed: Apr. 16, 2004

(51) Int. Cl. B65D 35/28; B43K 5/14

(52) U.S. Cl. 401/133

(57) ABSTRACT

Applicator devices and related methods for applying a composition to a user are disclosed. An applicator device for applying a composition includes a flexible container configured to hold the composition. The device further includes a body containing a piercing section having a piercing element for piercing the flexible container upon movement of the flexible container from a storage position to a use position. The body also contains a passage in the flexible container. A flexible gripping section has a pair of opposing substantially planar elements for selective squeezing engagement of the flexible container to force the composition out of the flexible container. An applicator tip member coupled to the body receives the composition from the passage upon squeezing the flexible gripping section.

### FIELD

The present invention relates generally to applicator devices for a composition, such as a fluid or flowable material, teeth and mouth cleaning devices, oral composition applicator devices, topical composition applicator devices and related methods.

### BACKGROUND

Mouth cleaning devices for teeth and breath freshening are known for home application. However, most users are unwilling to carry standard mouth cleaning devices with them as part of their daily activities because they are inconvenient to carry. One common mouth cleaning device that most users do not carry with them on a daily basis is a toothbrush and toothpaste. Typically, the need for a rinsing composition such as water makes carrying this device impractical or inconvenient.

Mouth fresheners are another mechanism employed to clean the mouth of a user. In one form commonly used in a home application, mouth fresheners are provided as a liquid. However, a liquid form may make these types of mouth fresheners difficult to carry. To address this problem, mouth fresheners are also provided in more portable forms such as mints and gums. However, these forms of mouth fresheners may not be sufficiently effective in removing food, germs or other material buildup in the mouth.

In order to provide better mouth cleaning and portability, various portable and reusable toothbrushes containing toothpaste have been developed. However, these devices may not provide adequate sanitary storage between uses. For example, a toothbrush may be difficult to maintain clean before use since it tends to catch debris in its bristles, etc. Another shortcoming of many devices is that they are incapable of simultaneously providing quick and easy operation, and inexpensive production. In particular, these devices oftentimes require complex piping and pumping structure, or require manipulation of a round tube of toothpaste in a wet environment. Complex piping and pumping structure also makes these type devices impractical to miniaturize, which improves their portability.

Other devices that are similar to the above-described portable toothbrush/toothpaste devices have been developed to protect the toothpaste by enclosing it in a sealed container to be opened upon use. These devices, however, are difficult to miniaturize because the conventional viscosity of toothpaste requires a passage of a particular dimension. These devices also may not provide any mechanism to prevent spillage or metered delivery of the toothpaste. Currently, these devices have not been applied to a mouthwash-like oral material.

In view of the foregoing, there is a need for a composition applicator device, including applicator devices for oral compositions, topical compositions, etc. that overcomes these shortcomings and may provide one or more advantageous features.

### SUMMARY

The present invention relates to an applicator device for applying a composition. The device includes a flexible container configured to hold the composition, a body containing a piercing section including a piercing element for piercing the flexible container upon movement of the flexible container from a storage position to a use position. The body also contains a passage in the flexible container. A flexible gripping section has a pair of opposing substantially planar elements for selective squeezing engagement of the flexible container to force the composition out of the flexible container. An applicator tip member coupled to the body receives the composition from the passage upon squeezing the flexible gripping section.

The present invention further relates to a method of making an applicator device for applying composition to a user. The method includes the steps of a) providing a body including a passage extending through a piercing element of the body; b) providing an applicator tip member configured to apply the composition on the body via the passage; and c) coupling a flexible container, configured to hold the composition, to the body such that the piercing element pierces the flexible container upon movement of the flexible container from a storage position to a use position. The flexible container includes a pair of opposing substantially planar elements that extend as part of the body to communicate the composition to the applicator tip member.

The present invention further relates to an applicator device which includes a flexible container for holding an oral composition. The body is configured to hold the flexible container in one of a storage position and a use position. The body also includes a passage in communication with the flexible container. Also included is a piercing section which includes a piercing element for piercing the flexible container upon movement of the flexible container from the storage position to the use position. An applicator tip member is coupled to the body to receive the oral composition from the passage upon squeezing of the flexible container.

### BRIEF DESCRIPTION OF THE DRAWINGS

FIGS. 1A-1B show a composition applicator device including common structure of exemplary embodiments.

FIGS. 2A-2M show an applicator device including a twist-off closure member according to an exemplary embodiment.

FIGS. 3A-3D show an applicator device including a piercing section (in cross-section) for a flexible oral composition container according to an exemplary embodiment.

FIGS. 3E-3F show detail of the applicator device according to an exemplary embodiment.

FIGS. 4A-4H show an applicator device according to an exemplary embodiment.

FIGS. 5A-5F show an applicator device including a slide actuator for an applicator surface according to an exemplary embodiment.

FIGS. 6A-6B show an applicator device including a cap activator according to an exemplary embodiment.

### DETAILED DESCRIPTION

Referring to the accompanying drawings, exemplary embodiments of an oral composition applicator device for applying an oral composition to a user's mouth are shown. As used, the term “mouth” includes all parts of the oral cavity including, for example, teeth, gums, inner cheek, tongue, etc. It should also be recognized that the term is intended to include humans, animals, etc.

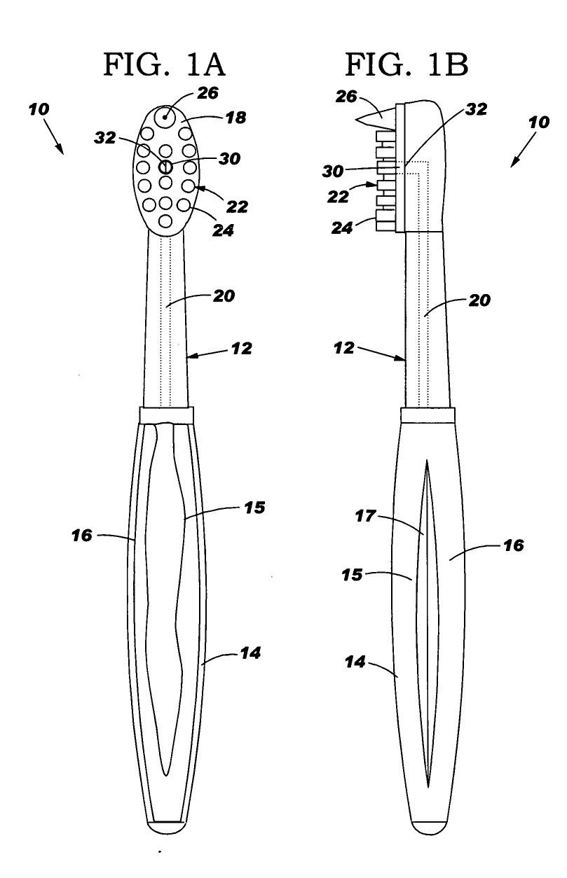

FIGS. 1A-1B show an applicator device including common structure of exemplary embodiments that will be used to describe the common components between the various embodiments. An applicator device 10 includes a body 12, a composition containment member 14 coupled to body 12 for holding an oral composition 16 (shown in partial cross-section in FIG. 1A), and an applicator tip member 18 coupled to body 12 to receive oral composition 16 from composition containment member 14 through a passage 20 in body 12. It will be apparent that the various embodiments, described below, include particular arrangements of the above-described structure, and FIGS. 1A-1B are not intended to be limiting to any one of the embodiments.

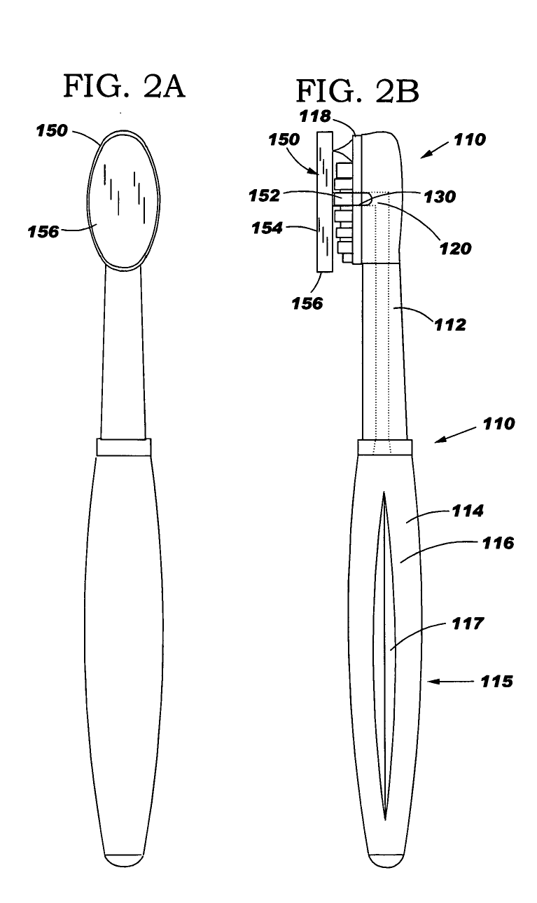

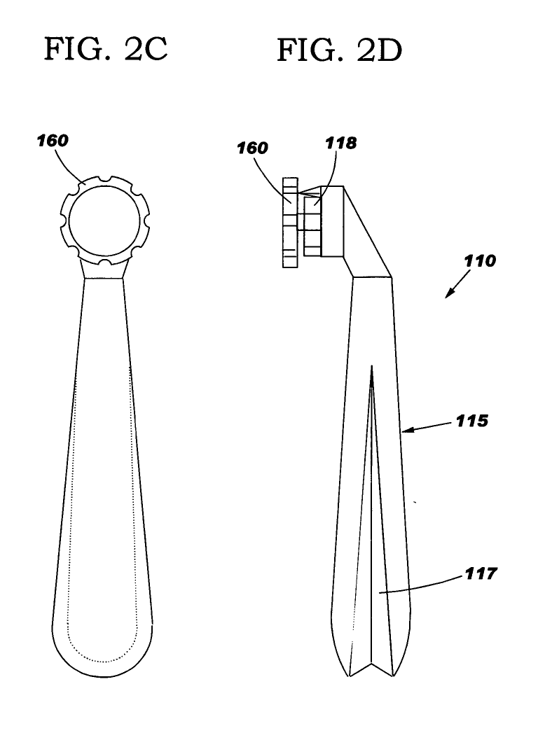

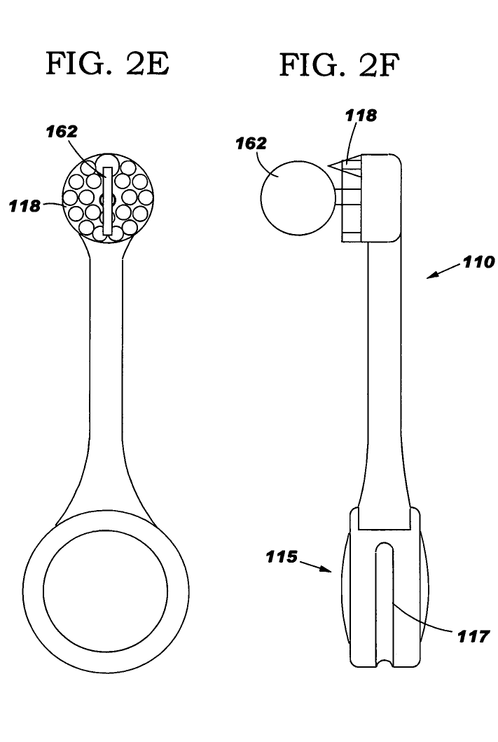

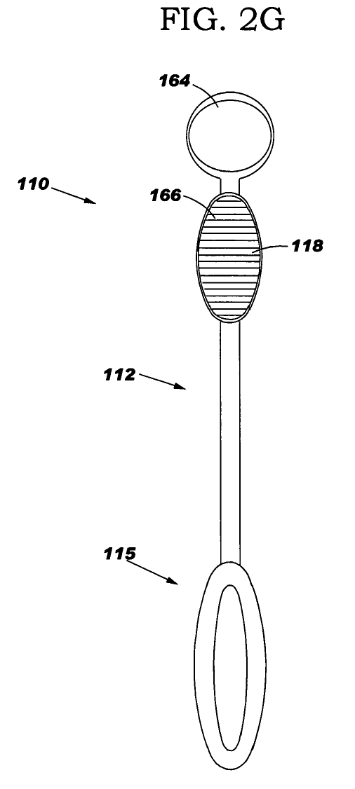

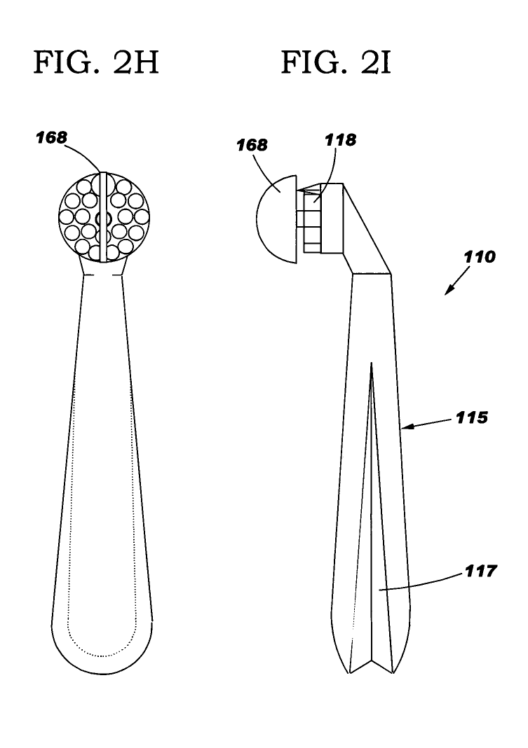

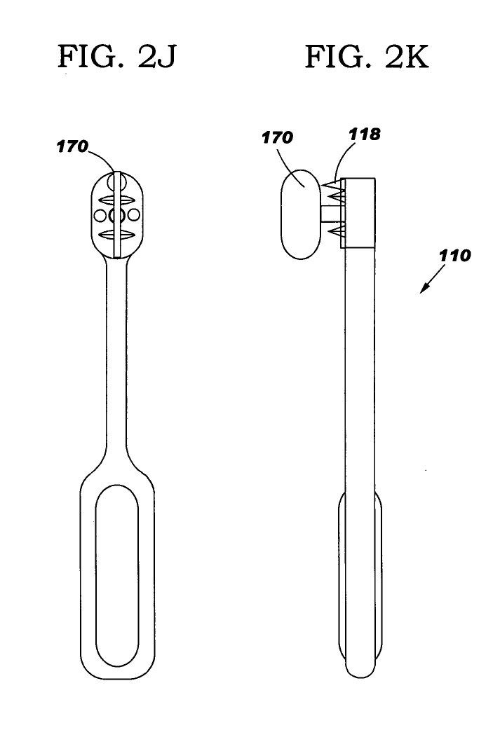

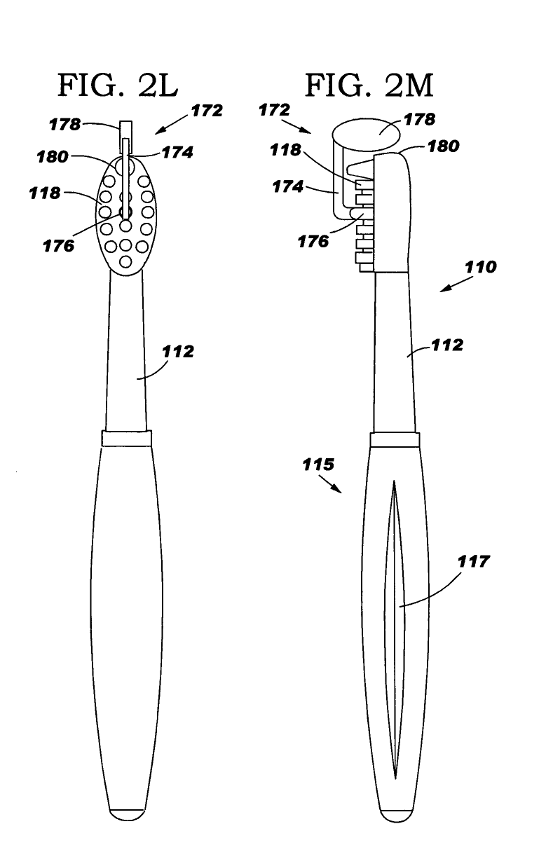

Composition containment member 14 is preferably made of a flexible material such as any medical grade polypropylene (PP), polyethylene (PE), polyethylene terephthalate (PET), cellulose acetate butyrate or similar material. In the embodiment shown, composition containment member 14 includes a squeeze section 15 made of flexible material. In many of the embodiments (FIGS. 2B, 2D, 2F, 2I, 2M, 3C, 4A, 4C, 4F, 4H and 4E), a squeeze section (e.g., sections 15,115, 215) may include at least one pleat or bellow (e.g., bellow 17, 117, 217) to facilitate squeezing of the squeeze section, i.e., collapsing of the squeeze section as oral composition 16 exits the composition containment member.

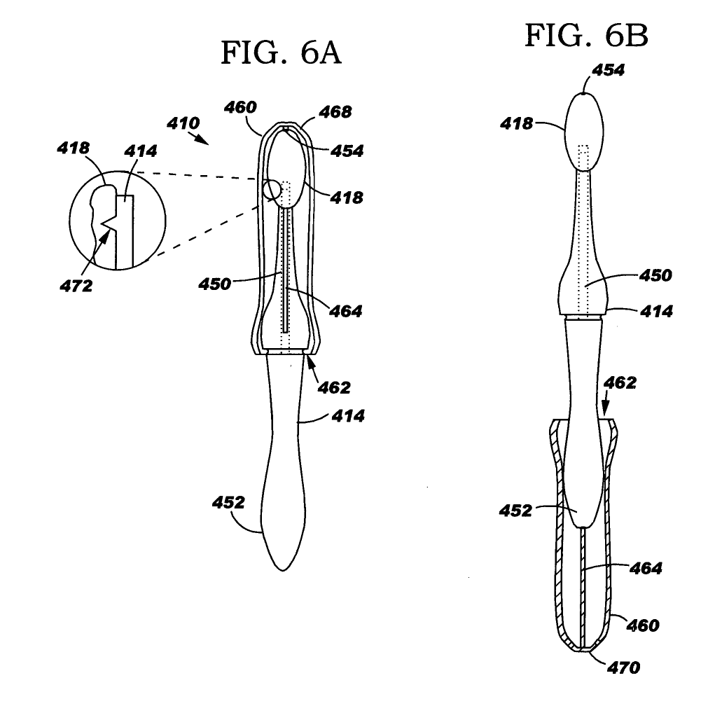

Applicator tip member 18 includes a surface 22 for applying oral composition 16 to the mouth of the user, e.g., for cleaning the mouth. Applicator tip member 18 is securely attached to the end of body 12 in a conventional manner, e.g., by gluing, heat staking, mechanically interlocking, laser welding, or the like. Applicator tip member 18 is securely fastened to or integrally molded with body 12 such that it is not easily dislodged or disconnected during use. In one embodiment, shown in FIGS. 6A-6B, an applicator tip member 418 has a surface 422 on all of the exposed surfaces. This allows the applicator device to be more efficient in cleaning the teeth. However, as illustrated by the other embodiments, this is not necessary.

Returning to FIGS. 1A-1B, surface 22 may be made from an abrasive material to assist in cleaning the mouth. Abrasive material useful in forming surface 22 may include all known abrasive materials as well as combinations and agglomerates of such materials. Softer abrasive particles (e.g., those having a Mohs' hardness in the range between 1 and 7) can be applied to provide surface 22. Suitable soft abrasives include, without limitation, inorganic materials such as flint, silica, pumice, and calcium carbonate as well as organic polymeric materials such as polyester, polyvinylchloride, methacrylate, methylmethacrylate, polycarbonate, and polystyrene as well as combinations of any of the foregoing materials. With regard to the polymeric materials, surface 22 may have a hardness of about Shore 20A to about Shore 65A, and preferably about Shore 35A. It should be understood, however, that applicator tip member 18 may be made of other materials. In one alternative embodiment, applicator tip member 18 may be made of a sponge material. In this case, a wedge shape is preferred since it would allow applicator device 10 to be more useful in cleaning the spaces between a person's teeth. In another alternative embodiment, applicator tip member 18 includes a plurality of synthetic fibers or fibrous-type members that are compressed or secured together by any conventional means (e.g., a mesh). In this regard, the synthetic material should be sufficiently firm in order to allow applicator device 10 to be used in its desired manner of cleaning the mouth and can include polymeric or plastic materials, such as polyamides (e.g., nylon); polyesters (e.g., polybutylene terephthalate) as well as thermoplastic polymers of olefinic monomers, (e.g., ethylene, propylene, butylene, and the like). This includes their homopolymers and copolymers of these monomers with other ethylenically unsaturated monomers where the copolymer contains at least 25% of the olefinic monomer. Other polymeric material that can be used include the nylon type products prepared from reaction polycarboxylic acids with polyamines and suitable modifications thereof. Applicator tip member 18 can be, for example, a series of bristles such as those commonly used on toothbrushes today or a bundle of fibers held closely together.

The arrangement of surface 22 may vary depending on user preference. In one embodiment shown in FIGS. 1A-1B, applicator tip member 18 includes a plurality of nubs or round-ended members 24 and one or more picks (shown as pick 26). Nubs 24 provide gentle, yet resilient massaging of the mouth, while pick 26 allows for removal of food and/or other material from difficult to reach areas, e.g., between teeth. In addition to the above-described surface 22, applicator tip member 18 also includes at least one opening 30 that is in communication (e.g., fluid communication) with passage 20 such that oral composition 16 may pass to applicator tip member 18. Applicator device 10 may also include a valve 32 (FIG. 1A) positioned between composition containment member 14 and applicator tip member 18. In one embodiment, valve 32 is provided as a single direction metering valve that prevents spillage and allows metering of oral composition 16, such as a mitral valve positioned in opening 30 of applicator tip member 18. A “mitral valve” may be any valve that includes one or more flaps that close to seal passage of material. It should be recognized that while a mitral valve 32 has been illustrated, a variety of other valves may also be employed within body 12 to provide metering and prevent spillage as may be necessary. For example, a spring loaded check valve (not shown) may be employed rather than mitral valve 32.

Oral composition 16 may be any now known or later developed oral material such as toothpaste and/or mouthwash. According to an exemplary embodiment, oral composition 16 may be a material including at least one essential oil. Oral composition 16 may also include an essential oil mixture including menthol, thymol, eucalyptus, and/or methyl salicylate. An essential oil is typically a complex volatile liquid often derived from flowers, stems, leaves, or often an entire plant. Essential oils often contain terpenes (pinene, dipentene, etc.) and are used for perfumery and flavorings. Examples of suitable essential oils may be as described in U.S. Pat. No. 6,121,315 to Nair et al., which is hereby incorporated by reference for all purposes. According to alternative embodiments, other compositions, materials, fluids, etc. may be provided in applicator device 10 including fluid, semi-fluid or flowable materials such as ointments, creams, lotions, anti-fungal compounds, etc. Accordingly, these materials may be applied to the skin, body parts, etc. of the user instead of to the oral cavity.

Oral composition 16 may have a higher viscosity than a conventional liquid mouthwash to provide adequate adhesion to applicator tip member 18. In one embodiment, oral composition 16 may have a viscosity in the range of about 6000 to about 8000 centipoises (cps), and preferably about 7000 centipoises (cps) at room temperature as measured using a Brookfield viscometer Spindle #4. Oral composition 16 may be in any volume necessary to provide a user with a clean mouth. In one embodiment, an amount in the range of about 0.4 to about 0.5 fluid ounces has been found sufficient. It should be recognized, however, that different sized devices may require different volumes to address such issues as user preference, differing viscosity of oral composition, and oral composition losses in the device interior, e.g., passage 20 or adhesion to walls of containment member 14, etc.

1. Twist off Closure Member

Referring to FIGS. 2A-2B, an applicator device 110 that is substantially similar to applicator device 10 of FIGS. 1A-1B is shown. In this embodiment, a twist off closure member 150 is provided to close a passage 120 in body 112. Closure member 150 includes a plug 152 for closing passage 120 in body 112 and an engagement member 154 for rotatably removing plug 152 from passage 120. Plug 152 also closes an opening 130 in applicator tip member 118 that is provided to receive oral composition 16.

Engagement member 154 may have a shape configured for easy grasping and/or ease of packaging of applicator device 110. As shown in FIG. 2A, engagement member 154 has a shape to substantially match the shape of applicator tip member 118, e.g., elliptical. An outer surface 156 of engagement member 154 may have a form allowing easy gripping by a user, e.g., serrations, tackyness, one or more protrusions, etc. In FIGS. 2C-2D, an engagement member 160 has a substantially circular shape that extends substantially parallel to applicator tip member 18. In FIGS. 2E-2F, an engagement member 162 has a substantially circular shape that extends substantially perpendicular to applicator tip member 118. FIG. 2G illustrates an engagement member 164 that has a substantially circular shape. In this embodiment, engagement member 164 extends longitudinally from a body 112 that has a passage in a distal end 166 of body 112. In FIGS. 2H-2I, an engagement member 168 has a substantially semi-circular shape and extends substantially perpendicular to applicator tip member 118. In FIGS. 2J-2K, an engagement member 170 has a substantially oval shape and extends substantially perpendicular to applicator tip member 118.

FIGS. 2L-2M illustrate an engagement member 172 that extends beyond an extremity of applicator tip member 118. In this case, engagement member 172 includes a first element 174 coupled to a plug 176 and a second element 178 for gripping by the user. First element 174 extends substantially parallel to applicator tip member 118, and second element 178 extends over a distal end 180 of body 112. This embodiment provides an engagement member 172 having additional leverage capabilities compared to the above-described embodiments for ease of removal of plug 176.

In operation, a user twists off the twist off closure member by engaging and turning the engagement member of the closure member to remove the plug from the passage, and then applies the oral composition to the mouth, e.g., by manually rubbing the applicator tip member in/on the mouth. A twist off closure member provides an easy grip even in a wet environment, and provides leverage for easy removal. The closure member also maintains oral composition in a sterile environment until use is desired.

This embodiment may also include a method of generating applicator device 110 including: a) providing body 112 having passage 120 (FIG. 2B) in fluid communication with composition containment member 114 (FIG. 2B) that is configured to hold oral composition 116; b) providing applicator tip member 118 on body 112 for applying oral composition 116; and c) attaching a twist off closure member to body 112. As noted above, the twist off closure member includes a plug for extending through applicator tip member 118 to close passage 120 in body 112 and an engagement member. In addition, the twist off closure member is configured for twisting off by engaging and turning the engagement member of the twist off closure member to remove the plug from passage 120. It should be recognized that the above order of steps may be altered or varied as desired.

2. Piercing Section

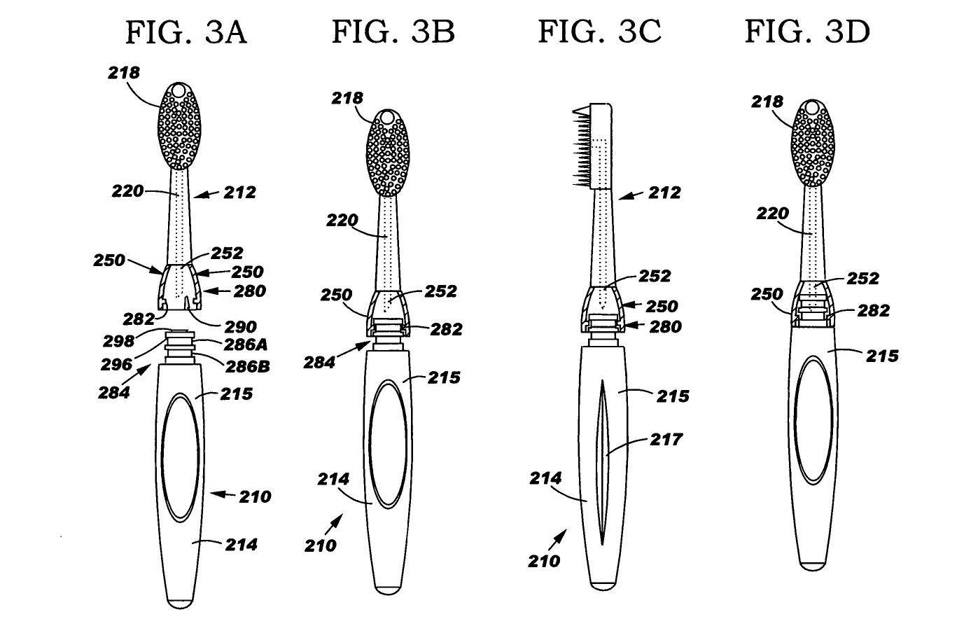

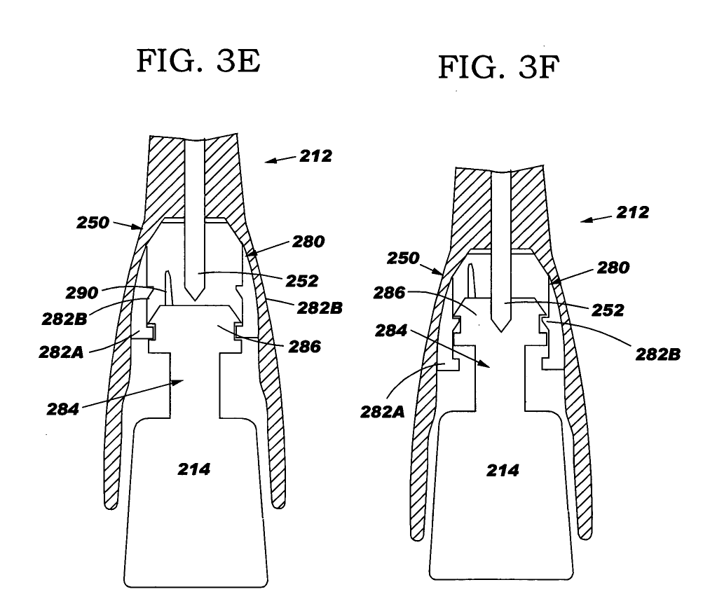

Referring to FIGS. 3A-3F, another exemplary embodiment is shown. A containment member 214 is movable between a storage position, in which containment member 214 is sealed, to a use position in which containment member 214 is pierced and oral composition is allowed to flow to an applicator tip member 218. Turning to FIGS. 3A-3D, FIG. 3A illustrates a front view of an applicator device 210 according to an exemplary embodiment with containment member 214 disconnected, FIGS. 3B-3C illustrate a storage position of applicator device 210 in a front view and a side view, respectively, with containment member 214 connected, and FIG. 3D illustrates a front view of applicator device 210 in a use position.

In this embodiment, an applicator device 210 includes a flexible container 214, i.e., composition containment member, for holding an oral composition (not shown), a body 212 configured to hold flexible container 214 in one of a storage position and a use position and including a passage 220 in communication with flexible container 214, a piercing section 250 including a piercing element 252 for piercing the flexible container upon movement of flexible container 214 from the storage position to the use position, and an applicator tip member 218 coupled to body 212 to receive oral composition from passage 220 in body 212 upon squeezing of the flexible container. Flexible container 214 is constructed in such a way as to allow selective squeezing of a squeeze section 215 to dispense the oral composition, but rigid in a longitudinal direction (in-line with body 212) such that movement of flexible container 214 is allowed in the longitudinal direction without collapse. As shown in FIG. 3C, squeeze section 215 may include at least one pleat or bellow 217 to facilitate squeezing of flexible container 214. Pleat(s) 217 may also add rigidity in the longitudinal direction.

As shown in FIGS. 3A-3D, body 212 also includes a piercing section 250 including a piercing element 252 for piercing flexible container 214 upon movement of flexible container 214 from a storage position, shown in FIG. 3B, to a use position, shown in FIG. 3D. Passage 220 extends through piercing element 252 to applicator tip member 218. As shown in FIG. 3A, flexible container 214 includes a sealing membrane 296 that may be covered by a protective metal cap 298, which would be removed prior to use. It should be recognized that FIG. 3A is provided for clarity in that flexible container 214 is preferably not provided to a user in a disconnected state from body 212, i.e., applicator device 210 is a single use device. However, according to an alternative embodiment, device 210 may be provided with one or more flexible containers 214 for selective attachment to body 212.

Body 212 also includes a holder 280 (shown in cross-section in FIGS. 3A-F) including at least one positioning ridge 282 for positioning a neck 284 of flexible container 214 in one of two positions, i.e., the storage position (FIGS. 3B-3C) and the use position (FIG. 3D). Neck 284 of flexible container 214 includes at least one complementary positioning element 286 that engages with positioning ridge(s) 282. In one embodiment, holder 280 is configured to hold flexible container 214 such that it is difficult to remove, may cause deformation/damage if removed once placed in the storage position, or irremovable. In addition, holder 280 is configured such that once flexible container 214 is moved to the use position, that movement is difficult to reverse or irreversible, i.e., flexible container 214 cannot be moved from the use position. It should be understood, however, if desired, flexible container 214 may be constructed of sufficiently pliable material or be of an arrangement such that removal from body 212 after use is possible.

As shown in FIGS. 3A-3D, holder 280 may include a single positioning ridge 282 and flexible container 214 may include a complementary storage positioning element 286A and a complementary use positioning element 286B. In the storage position shown in FIGS. 3B and 3C, positioning ridge 282 engages with complementary storage positioning element 286A to make it difficult to remove, cause deformation/damage if removed once placed in the storage position, or irremovably hold flexible container 214 in body 212 in an un-pierced (un-opened) state. Upon adequate force being applied to flexible container 214 towards body 212, flexible container 214 moves to the use position, shown in FIG. 3D. In this position, positioning ridge 282 engages with complementary use positioning element 286B. Also in this position, flexible container 214 is moved a distance sufficient for piercing element 252 to pierce sealing membrane 296 and open flexible container 214. Selective squeezing of flexible container 214 allows for dispensing of oral composition to applicator tip member 218.

Referring to FIGS. 3E-3F, an alternative embodiment of holder 280 is shown in cross-section. In this case, holder 280 may include a storage positioning ridge 282A and a use positioning ridge 282B, and flexible container 214 may include a positioning element 286 of neck 284. In the storage position shown in FIG. 3E, storage positioning ridge 282A engages with positioning element 286 to hold flexible container 214 in body 212, but in an un-pierced (un-opened) state. Upon adequate force being applied to flexible container 214 towards body 212, flexible container 214 moves to the use position, shown in FIG. 3F. In this position, use positioning ridge 282B engages with positioning element 286. Also in this position, flexible container 214 is moved a distance sufficient for piercing element 252 to pierce sealing membrane 296 and open flexible container 214. Selective squeezing of flexible container 214 forces oral composition through passage 220 to applicator tip member 218.

Movement of flexible container 214 relative to holder 280 may be accommodated in a number of ways. For example, holder 280 may include an expansion slot 290, if necessary, to allow for passage of neck 284 into holder 280. In another example, neck 284 may be provided of sufficiently pliable material to allow temporary deformation for passage into holder 280. In another example, ridge(s) 282 and/or positioning elements 286 may include angled surfaces to ease movement. The above-described structure may be applied individually or in any combination.

The traveling distance that flexible container 214 is allowed to be inserted into piercing section 250 can be controlled, for example, by the distance between positioning elements 286A, 286B and/or by an edge of neck 284 mating with an edge of body 212, as shown in FIG. 3D. The traveling distance is set so as to allow piercing/opening of flexible container 214 such that dispensing of oral composition from applicator tip member 218 does not take place prematurely during insertion. However, sufficient dispensing of oral composition into passage 220 may be provided such that any subsequent squeezing of flexible container 214 results in relatively quick delivery of oral composition to applicator tip member 218. In any event, selective squeezing of flexible container 214 forces oral composition through passage 220 to applicator tip member 218. The amount of oral composition dispensed can be easily selected by the user by the amount of pressure applied to flexible container 214.

As can be discerned by comparing FIGS. 3A-3D and FIGS. 3E-3F, holder 280 may be provided as an integral part of body 212 (FIGS. 3A-3D) or as a separate fixed member (FIGS. 3E-3F). In the latter case, holder 280 may be affixed by any now known or later developed manner of affixing two components, e.g., adhesive, welds, mechanical fasteners, etc. It should be recognized that other arrangements for holding flexible container 214 in the two positions are also possible.

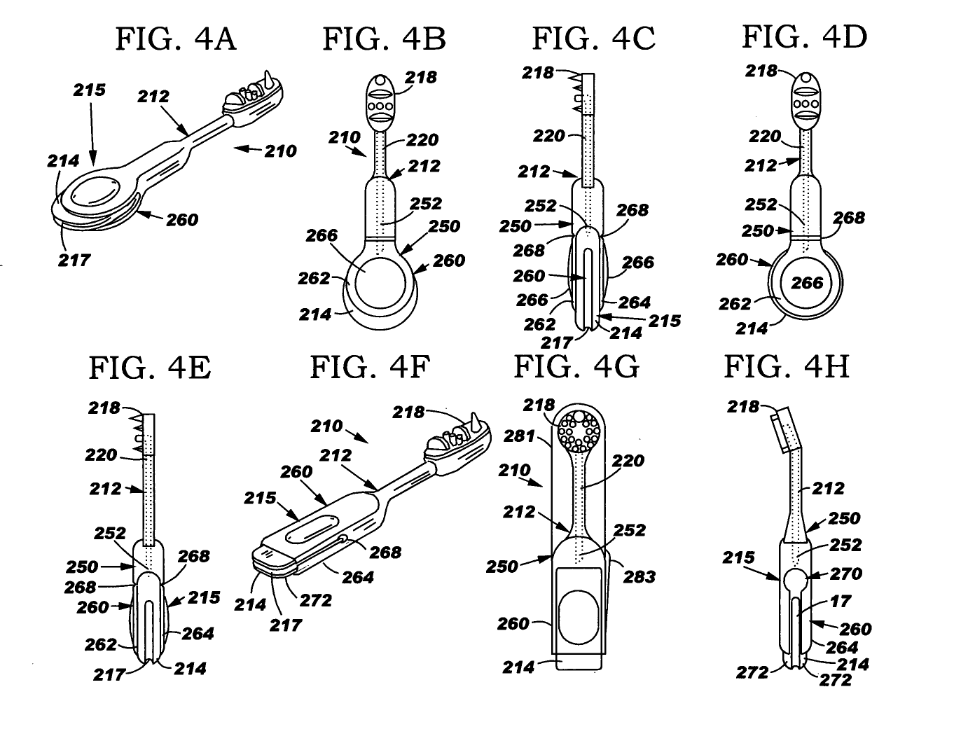

Turning to FIGS. 4A-4H, alternative embodiments of an applicator device 210 having a piercing section 250 is illustrated. In this embodiment, body 212 also includes a flexible gripping section 260 having a pair of opposing substantially planar elements 262, 264 that partially enclose flexible container 214. Planar elements 262, 264 provide surfaces for selective squeezing engagement of flexible container 214 to force the oral composition out of flexible container 214. Flexible gripping section 260 is open around a perimeter portion. According to a preferred embodiment, gripping section 260 is open around a substantial portion of the circumference. Although not necessary, flexible container 214 preferably has a shape that is substantially similar to planar elements 262, 264 to allow for equal distribution of force to flexible container 214. In addition, the traveling distance that flexible container 214 is allowed to be inserted into piercing section 250 can be controlled by an outer extremity of planar elements 262, 264 such that dispensing of oral composition does not take place prematurely during insertion and/or passage 220 is sufficiently filled such that any subsequent squeezing of planar elements 262, 264 results in dispensing of oral composition to applicator tip member 218. That is, flexible container 214 can be inserted only so far as allowed by planar elements 262, 264. In this case, holder 280 (FIGS. 3A-3F) may be eliminated, although that is not necessary. Each substantially planar element 262, 264 may include a gripping surface 266 that may be co-molded with gripping section 260 of, for example, a tacky material. In addition, as shown in FIGS. 4B-4E, in order to allow flexing of planar elements 262, 264, each element may be coupled to piercing section 250 by a thinned flexure 268.

Turning to FIGS. 4F-4H, optional structures and an optional shape for this embodiment are shown. FIGS. 4F-4H collectively illustrate that the shape of body 212 including piercing section 250 and flexible gripping section 260 may be altered to accommodate different shaped flexible containers 214 and different users. In addition, thinned flexures 268 (FIGS. 4B-4E) may be replaced by a yoke 270, which allows similar flexing of planar elements 262, 264. FIGS. 4F and 4H also illustrate an optional implementation of a detent 272 on each planar element 262, 264. In use, as flexible gripping section 260 is squeezed by a user, detents 272 of the opposing planar elements 262, 264 engage to limit motion. In this fashion, the amount of movement allowed by the detents determines an amount of oral composition received by applicator tip member 218. Detents 272 can thus be sized to control the amount of oral composition delivered.

FIG. 4G illustrates an optional implementation of a cap 281 to enclose applicator tip member 218 and provide further sanitary precautions. Cap 281 may also include a pick 283 that extends beyond an edge of cap 281 for use in cleaning food and other material form the teeth of the user. FIG. 4H illustrates angling of applicator tip member 218, i.e., the applicator tip member end of body 212, relative to piercing section 250 to allow a user to readily reach different areas of the mouth.

This exemplary embodiment may also include a method of applying an oral composition to a mouth of a user including: a) providing applicator device 210 having flexible container 214 coupled to body 212 that is in fluid communication with applicator tip member 218; b) piercing flexible container 214 by moving the flexible container from a storage position to a use position; c) squeezing flexible container 214 with a pair of opposing substantially planar elements 262, 264 that extend as part of body 212 to communicate oral composition 216 to applicator tip member 218; and d) applying the oral composition to the mouth of the user. Application may occur by manually rubbing the applicator tip member on the mouth of the user.

This exemplary embodiment may also include a method of generating applicator device 210 including: a) providing body 212 including passage 220 extending through piercing element 252 of the body; b) providing applicator tip member 218 that is configured to apply the oral composition 216 on the body via the passage; c) coupling flexible container 214 to the body such that the piercing element pierces the flexible container upon movement of the flexible container from a storage position to a use position; and d) allowing the flexible container to be squeezed with a pair of opposing substantially planar elements 262, 264 that extend as part of the body to communicate the oral composition to the applicator tip member. As noted above, the coupling step may include coupling (such as irremovably coupling, engaging, locking, etc.) flexible container 215 to body 212 in the storage position such that movement to the use position causes piercing of the flexible container. In addition, movement to the use position may be difficult to reverse, irreversible, etc.

3. Movable Applicator Surface

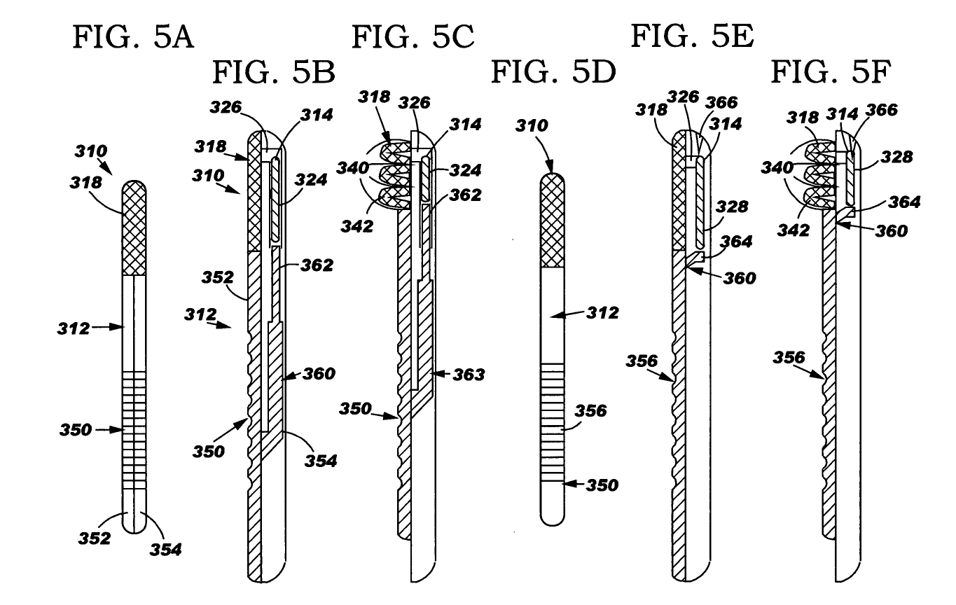

Referring to FIGS. 5A-5F, an applicator device 310 is shown including a body 312, a composition containment member 314 (shown in cross-section in FIGS. 5B-5C and 5E-5F) coupled to body 312 and configured to hold an oral composition (not shown). An applicator tip member in the form of an applicator surface 318 is coupled to the body to receive the oral composition from the composition containment member. As illustrated by comparing, for example, FIGS. 5B and 5C, applicator surface 318 is movable between a storage position (FIG. 5B) and a use position (FIG. 5C) by an activator 350 coupled to applicator surface 318. In the storage position, also shown in FIG. 5E, applicator surface 318 is substantially planar (flat, contained substantially in one plane, slightly curved, etc.) such that applicator device 310 can be easily carried, e.g., by sliding into a user's pocket, etc., and maintained sanitary since it is resistant of catching debris. A cover (not shown) of material may also be provided to protect applicator surface 318. In the use position, shown in FIGS. 5C and 5F, applicator surface 318 has a substantially non-planar shape (serpentine or other curved, non-planar, irregular or other shaped surfaces) such that it can be used to apply oral composition to the mouth of the user, and to remove food and other material similar to a toothbrush. In one embodiment, intermittent portions 340 of applicator surface 318 are permanently attached such that when surface 318 is longitudinally compressed, non-attached portions 342 are forced out-of-plane to form the substantially non-planar shape shown in FIGS. 5C and 5F. It should be recognized that other mechanisms for allowing the planar to non-planar movement are possible.

In the embodiment shown in FIGS. 5A-5C, activator 350 includes a first sliding member 352 movable between a first position (FIG. 5B) in which applicator surface 318 is in the storage position and a second position (FIG. 5C) in which applicator surface 318 is in the use position. In addition, activator 350 includes a second independently movable sliding member 354 coupled to a composition dispensing member 360 for communicating a selective amount of the oral composition to the applicator tip member 318 from containment member 314. In contrast, in FIGS. 5D-5F, applicator surface 318 and composition dispensing member 360 are coupled to a single sliding member 356. Applicator device 310 shown in FIGS. 5B-5C embodiment allows a user to activate applicator surface 318 alone, rather than simultaneously with communication of oral composition. In this fashion, a user can use applicator surface 318 without oral composition provided, e.g., without any oral composition or with another oral composition than that provided.

As can be observed by comparing FIGS. 5B-5C with FIGS. 5E-5F, composition dispensing member 360 can vary in structure depending on how containment member 314 is provided. In FIGS. 5B-5C, composition dispensing member 360 includes a piston 362 movable through a containment member 324 in the form of an elongated chamber to communicate the oral composition to applicator tip member 318. An opening 326 in applicator tip member 318 is provided such that oral composition can dispense from behind the serpentine or non-planar applicator surface. In FIGS. 5E-5F, composition dispensing member 360 includes an engagement member 364 for engaging a containment member 314 in the form of a burstable package 328. Engagement member 364 moves burstable package 328 to a bursting position (FIG. 5F) where it is pierced by a pick 366. Additional movement of sliding member 356 dispenses the oral composition to applicator tip member 318.

In use, applicator surface 318 is moved from the planar storage position to the substantially serpentine or non-planar use position, and the oral composition is communicated from the composition containment member to the applicator tip member. A user may then apply the oral composition to the mouth, e.g., by manually rubbing the applicator tip member on the mouth. Applicator device 310 maintains a sanitary applicator surface prior to use, and allows for easy storage/carrying of the applicator device.

This embodiment also includes a method of generating an applicator device 310 including: a) providing body 312 coupled to a composition containment member 314 that is configured to hold an oral composition (not shown), the body including an applicator surface 318; b) allowing movement of the applicator surface from a planar storage position (FIGS. 5A, 5B and 5E) to a substantially serpentine or non-planar use position (FIGS. 5C and 5F); and c) allowing passing of the oral composition from the composition containment member to the applicator surface.

4. Cap-Activated Dispensing

Referring to FIGS. 6A-6B, an applicator device 410 for cleaning or applying an oral composition to a mouth of a user is illustrated. In this embodiment, applicator device 410 includes: an oral composition containment member in the form of a flexible container 414 including an open end 450 and a closed end 452; an applicator tip member 418 coupled to open end 450 and including an opening 454 for receiving oral composition 416 from flexible container 414; and a cap 460 (shown in cross-section) having an open end 462 and a protrusion 464 extending toward open end 462 thereof. In a storage position, shown in FIG. 6A, protrusion 464 extends through open end 450 of flexible container 414 and opening 454 of applicator tip member 418 to maintain oral composition 416 in flexible container 414. In this case, cap 460 is in a first telescoping position with flexible container 414 such that flexible container 414 is at least partially contained within cap 460. In moving to a use position, shown in FIG. 6B, a user grasps closed end 450 of flexible container and removes the container from cap 460. In so doing, protrusion 464 is removed from flexible container 414. Cap 460 is then be flipped such that closed end 452 of flexible container 414 may be inserted therein and protrusion 464 selectively engaged against flexible container 414 to dispense oral composition 416 to applicator tip member 418.

Cap 460 may include a closed end 468 (FIG. 6A) or a partially open end 470 (FIG. 6B) to allow venting. As shown in the detail portion of FIG. 6A, in one embodiment, applicator tip member 418 may be coupled to open end 450 of flexible container 414 by a male-female connector 472 to prevent removal of applicator tip member 418 during movement of cap 460. It should be recognized, however, that other connection mechanisms may be employed.

Cap 460 provides a compact applicator device 410 that is sterile prior to use and quick and easy to operate.

This embodiment includes a method of applying an oral composition to a mouth of a user including: a) providing a flexible container 314 for holding an oral composition and including an open end 450 and a closed end 452; b) providing an applicator tip member 418 at the open end 452, the applicator tip member including an opening 454 for receiving the oral composition from the flexible container; c) providing a cap 460 on the open end, the cap including an open end 462 and a protrusion 464 extending toward the open end of the cap and through the open end of the flexible container to maintain the oral composition in the flexible container; d) placing the cap on the closed end of the flexible container such that selective engagement of the cap on the closed end of the flexible container dispenses the oral composition to the applicator tip member; and e) applying the oral composition to the mouth of the user, e.g., by manually rubbing the applicator tip member on the mouth of the user.

The embodiment may also include a method of generating an applicator device 410 including: a) providing a flexible container 414 for holding an oral composition and including an open end 450 and a closed end 152; b) providing an applicator tip member 418 at the open end, the applicator tip member including an opening for receiving the oral composition from the flexible container; c) placing a cap 460 on the open end, the cap including an open end 462 and a protrusion 464 extending toward the open end of the cap and through the open end of the flexible container to maintain the oral composition in the flexible container; and d) allowing removal of the cap to remove the protrusion from the open end of the flexible container and placement of the cap on the closed end of the flexible container such that selective engagement of the cap on the closed end of the flexible container dispenses the oral composition to the applicator tip member.

The construction and arrangement of the elements of the system as shown in the exemplary, preferred and alternative embodiments is illustrative only. Although only a few embodiments have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, operating conditions and arrangement of the preferred and other exemplary embodiments without departing from the scope of the present invention. The scope of these and other changes will become apparent from the appended claims.

1. An applicator device for applying a composition comprising:
a flexible container configured to hold the composition;
a body having:
a piercing section including a piercing element for piercing the flexible container upon movement of the flexible container from a storage position to a use position,
a passage in communication with the flexible container, and
a flexible gripping section having a pair of opposing substantially planar elements for selective squeezing engagement of the flexible container to force the composition out of the flexible container; and
an applicator tip member coupled to the body to receive the composition from the passage upon squeezing of the flexible gripping section.

2. The applicator device of claim 1, wherein the flexible container includes least one pleat to facilitate squeezing of the flexible container.

3. The applicator device of claim 1, wherein each substantially planar element includes a detent for engagement with the detent of the opposing planar element, whereby the amount of movement allowed by the detents determines an amount of composition received by the applicator tip member.

4. The applicator device of claim 1, further comprising a cap to enclose the applicator tip member.

5. The applicator device of claim 1, wherein the body includes a holder having at least one positioning ridge and the flexible container includes at least one complementary positioning element for engagement with the at least one positioning ridge.

6. The applicator device of claim 5, wherein the holder includes a single positioning ridge and the flexible container includes a complementary use positioning element for engagement with the positioning ridge in the use position, and a complementary storage positioning element for engagement with the single positioning ridge in the storage position.

7. The applicator device of claim 5, wherein the holder includes a use positioning ridge and a storage positioning ridge, and the flexible container includes a single complementary positioning element for engagement with the use positioning ridge in the use position and with the storage positioning ridge in the storage position.

8. The applicator device of claim 1, wherein the applicator tip member includes a plurality of nubs and at least one pick.

9. The applicator device of claim 1, further comprising at least one of an oral composition and a topical composition.

10. The applicator device of claim 9, wherein the oral composition includes at least one essential oil and has a viscosity of no less than about 6000 centipose (cps) and no greater than about 8000 cps.

11. The applicator device of claim 9, wherein the oral composition includes a mixture including menthol, thymol, eucalyptus, and methyl salicylate.

12. The applicator device of claim 1, wherein the body further comprises at least one of a valve and a single direction metering valve.

13. A method of making an applicator device for applying composition to a user, the method comprising the steps of:
a) providing a body including a passage extending through a piercing element of the body;
b) providing an applicator tip member configured to apply the composition on the body via the passage; and
c) coupling a flexible container, configured to hold the composition, to the body such that the piercing element pierces the flexible container upon movement of the flexible container from a storage position to a use position;
wherein the flexible container includes a pair of opposing substantially planar elements that extend as part of the body to communicate the composition to the applicator tip member.

14. The method of claim 13, wherein the coupling step includes irremovably coupling the flexible container to the body in the storage position such that movement to the use position causes piercing of the flexible container.

15. The method of claim 14, wherein movement to the use position is irreversible.

16. An applicator device comprising:
a flexible container for holding a composition;
a body configured to hold the flexible container in one of a storage position and a use position, the body including a passage in communication with the flexible container;
a piercing section including a piercing element for piercing the flexible container upon movement of the flexible container from the storage position to the use position; and
an applicator tip member coupled to the body to receive the composition from the passage upon squeezing of the flexible container.

17. The applicator device of claim 16, further comprising a cap to enclose the applicator tip member.

18. The applicator device of claim 17, wherein the cap includes a pick for use in cleaning teeth of the user.

19. The applicator device of claim 16, further comprising at least one of an oral composition, a cream, an ointment, a fluid, and a flowable material.

20. The applicator device of claim 19, wherein the oral composition includes a mixture including menthol, thymol, eucalyptus, and methyl salicylate.
